(19) United States
(12) Patent Application Publication
(10) Pub. No.: US 2020/0247980 A1
(43) Pub. Date: Aug. 6, 2020

(54) PHENOLIC RESINS BLENDED WITH ANTIOXIDANTS

(71) Applicant: SI GROUP-SHANGHAI CO., LTD., Shanghai (CN)

(72) Inventors: Changzheng DONG, Shanghai (CN); Li SONG, Shanghai (CN); Chao SONG, Shanghai (CN); Zhengwu FENG, Shanghai (CN)

(21) Appl. No.: 16/753,187

(22) PCT Filed: Sep. 28, 2018
(86) PCT No.: PCT/CN2018/108179

§ 371 Date: Apr. 2, 2020

Related U.S. Application Data
(60) Provisional application No. 62/567,569, filed on Oct. 3, 2017.

(51) Int. Cl. C08L 7/00; C08G 8/12; C08K 5/11; C08K 5/101; C08K 5/13; C08K 5/103; C08L 9/00

(52) U.S. Cl. CPC C08L 7/00; C08G 8/12; C08K 5/11; C08K 5/101; C08K 5/13; C08L 2310/00; C08L 9/00; C08K 2201/014; C08L 2201/08; C08L 2205/035; C08L 2207/322; C08K 5/103

(57) ABSTRACT

This invention relates to a phenolic resin composition comprising: a) about 50 wt % to about 95 wt % of one or more alkylphenol-aldehyde resins and b) about 5 wt % to about 50 wt % of an antioxidant composition. This invention also relates to a process of reducing hysteresis and/or improving scorch in a phenolic resin. This invention also relates to a process of recycling by-products of a reaction between an alkyl acrylate and an alkylphenol compound.

### FIELD OF THE INVENTION

This invention generally relates to a phenolic resin composition. This invention also generally relates to a process of reducing hysteresis and/or improving scorch in a phenolic resin.

### BACKGROUND

Phenolic resins are commonly used in rubber compounds to improve the properties or performances of the rubber compounds. For instance, phenolic resin can be used as a tackifier, to impart a desired level of tack to a rubber compound to allow it to be assembled with other rubber compounds into an article (e.g., a tire or a multi-layer hose). However, adding a phenolic resin, such as a tackier resin, to a rubber compound can adversely increase the heat buildup of the final rubber article, which can lead to the degradation of the rubber article. Adding a phenolic resin to a rubber compound can also adversely deteriorate the scorch time of the rubber compound. Therefore, there remains a need to develop a process to prepare a phenolic resin with reduced heat buildup and improved scorch resistance to a rubber composition while maintaining other properties that the resin introduces into the rubber composition, such as the tackiness.

Hindered phenol antioxidants have been widely manufactured and used for combating the destructive effects of oxidation in organic materials. Typical methods for preparing some hindered phenol antioxidants involve a Michael reaction between an alkylphenol and an alkyl acrylate such as methyl acrylate, followed by isolation of the resulting phenolic esters from a reaction product containing large amounts of by-products. Purified forms of these esters are typically desired for utilization as antioxidants. The manufacture of these hindered phenolic esters often result in large amounts of distillation bottom fractions accumulating quickly in the distillation reactors as waste materials, creating difficult problems for waste disposal.

There thus also remains a need to resolve the waste disposal problem associated with the manufacture of the hindered phenolic esters via the Michael reaction. This invention answers those needs.

### SUMMARY OF THE INVENTION

One aspect of the invention relates to a phenolic resin composition, comprising: a) about 50 wt % to about 95 wt % of one or more alkylphenol-aldehyde resins and b) about 5 wt % to about 50 wt % of an antioxidant composition. The alkylphenol in the alkylphenol-aldehyde resin includes butylphenol and/or octylphenol. The antioxidant composition comprises i) about 50-90 wt % pentanedioic acid, 2-[3,5-di-tert-butyl-4-hydroxybenzyl] C₁-C₁₀ dialkyl ester; ii) about 0.1-25 wt % 3,5-di-tert-butyl-4-hydroxyhydrocinnamic acid, C₁-C₁₀ alkyl ester; iii) about 3-20 wt % 3,3′,5,5′-tetra-tert-butyl-4,4′-biphenol; iv) about 3-20 wt % 2,2′,6,6′-tetra-tert-butyl-4,4′-methylenediphenol; and v) about 0.1-10 wt % methyl 3-(3,5-di-tert-butyl-4-oxocyclohexa-2,5-dien-1-ylidene) propanoate.

Another aspect of the invention relates to a process of reducing hysteresis and/or improving scorch in a phenolic resin, comprising: mixing a) a phenolic resin composition comprising one or more alkylphenol-aldehyde resins; and b) an antioxidant composition. The antioxidant composition comprises i) pentanedioic acid, 2-[3,5-di-tert-butyl-4-hydroxybenzyl]C₁-C₁₀ dialkyl ester; ii) 3,5-di-tert-butyl-4-hydroxyhydrocinnamic acid, C₁-C₁₀ alkyl ester; iii) 3,3′,5,5′-tetra-tert-butyl-4,4′-biphenol; iv) 2,2′,6,6′-tetra-tert-butyl-4,4′-methylenediphenol; and v) methyl 3-(3,5-di-tert-butyl-4-oxocyclohexa-2,5-dien-1-ylidene) propanoate. The addition of the antioxidant composition to the phenolic resin composition provides reduced hysteresis and/or improved scorch resistance to a rubber composition containing the phenolic resin composition.

Another aspect of the invention relates to a process of recycling by-products of a reaction between an alkyl acrylate and an alkylphenol compound. The process comprises collecting the residuum fraction by-products of the reaction between the alkyl acrylate and the alkylphenol compound, wherein the alkylphenol compound includes 2,6-di-tert-butylphenol or 2,4-di-tert-butylphenol; and mixing the by-products with a tackifier resin composition comprising one or more alkylphenol-aldehyde resins, thereby recycling the by-products as a tackifier composition.

### BRIEF DESCRIPTION OF THE DRAWINGS

FIG. 1 shows the results of Mooney Scorch time (min) measured at 127° C. with a test time of 60 minutes for the rubber compositions containing various tackifier resin samples.

FIG. 2 shows the results of Mooney viscosity (ml) measured at 100° C. with a test time of 4 minutes for the rubber compositions containing various tackifier resin samples.

FIGS. 3A-3D show the results of rheological measurements using an MDR 2000 rheometer produced at 151° C. with a test time of 30 minutes (FIGS. 3A-3B) and at 185° C. with a test time of 10 minutes (FIGS. 3C-3D) for the rubber compositions containing various tackifier resin samples.

FIG. 4A shows the results of stress properties of the rubber compound cured at 151° C. measured at ambient temperature, and FIG. 4B shows the results of elongation properties of the rubber compound cured at 151° C. measured at ambient temperature, for the rubber compositions containing various tackifier resin samples.

FIGS. 5A-5B show the results of tan 6 values for the rubber compositions containing various tackifier resin samples, determined by a RPA instrument at a series of strains at 60° C., and with a frequency of 1 Hz (FIG. 5A) and 10 Hz (FIG. 5B), respectively.

FIG. 6 shows the results of hysteresis for the rubber compositions containing various tackifier resin samples obtained by a BF Goodrich Flexometer Model II.

FIG. 7 shows the results of tack performance for the rubber compositions containing various tackifier resin samples.

The tackifier resin samples in FIGS. 1-7 are described in Example 2.

### DETAILED DESCRIPTION OF THE INVENTION

Tires and other technical rubber articles are employed in many applications that undergo dynamic deformations. The amount of energy stored or lost as heat during these deformations is known as “hysteresis” (or heat buildup). Hysteresis is often monitored and assessed, as too much hysteresis can affect the performance and longevity of certain rubber products.

Phenolic resins are commonly used in rubber compounds to improve the properties or performance of the rubber compounds. However, using these resins typically leads to increases in heat buildup upon dynamic stress of the rubber article.

Adding a phenolic resin (e.g., an alkylphenol-aldehyde resin) in rubber compounds can also adversely deteriorate the scorching property of the rubber compounds (that is, shorten the scorch time).

This invention relates to the unexpected discovery that the use of particular antioxidant composition in combination with an alkylphenol-aldehyde resin, in a rubber formula, reduces the increase in the heat buildup upon dynamic stress of the rubber article that is otherwise caused by introducing a phenolic resin into the rubber article and/or improves the scorch properties that are otherwise worsened by introducing a phenolic resin into the rubber composition. Adding an alkylphenol-aldehyde resin (such as a tackifier resin) to a rubber composition generally increased the heat buildup and deteriorates the scorching property of the rubber composition. However, when the same alkylphenol-aldehyde resin was added together with an antioxidant composition disclosed in this application, the heat buildup of the rubber composition was reduced and the scorch time was improved (extended). These improvements were consistent for all concentrations of the antioxidant composition tested and over various commercial alkylphenol-aldehyde tackifier resins. The other physical properties and tack performance of the rubber composition had not been affected by adding the disclosed antioxidant composition.

Accordingly, one aspect of the invention relates to a phenolic resin composition, comprising: a) about 50 wt % to about 95 wt % of one or more alkylphenol-aldehyde resins and b) about 5 wt % to about 50 wt % of an antioxidant composition. The alkylphenol in the alkylphenol-aldehyde resin includes butylphenol and/or octylphenol. The antioxidant composition comprises i) about 50-90 wt % pentanedioic acid, 2-[3,5-di-tert-butyl-4-hydroxybenzyl] C₁-C₁₀ dialkyl ester; ii) about 0.1-25 wt % 3,5-di-tert-butyl-4-hydroxyhydrocinnamic acid, C₁-C₁₀ alkyl ester; iii) about 3-20 wt % 3,3′,5,5′-tetra-tert-butyl-4,4′-biphenol; iv) about 3-20 wt % 2,2′,6,6′-tetra-tert-butyl-4,4′-methylenediphenol; and v) about 0.1-10 wt % methyl 3-(3,5-di-tert-butyl-4-oxocyclohexa-2,5-dien-1-ylidene) propanoate.

The component a) in the phenolic resin composition contains one or more alkylphenol-aldehyde resins. The alkylphenol in the alkylphenol-aldehyde resin includes butylphenol (e.g., para-tert-butylphenol, PTBP) and/or octylphenol (e.g., para-tert-octylphenol, PTOP). In one embodiment, the alkylphenol in the alkylphenol-aldehyde resin is a mixture of PTBP and PTOP.

The alkylphenol-aldehyde resin can be prepared by condensation reaction of the alkylphenol with one or more aldehydes using any suitable methods known in the art. Any aldehyde known in the art suitable for alkylphenol-aldehyde condensation reaction may be used to form the phenolic resins. Exemplary aldehydes include formaldehyde, methylformcel, butylformcel, acetaldehyde, propionaldehyde, butyraldehyde, crotonaldehyde, valeraldehyde, caproaldehyde, heptaldehyde, benzaldehyde, as well as compounds that decompose to aldehyde such as paraformaldehyde, trioxane, furfural, hexamethylenetriamine, aldol, P3-hydroxybutyraldehyde, and acetals, and mixtures thereof. A typical aldehyde used is formaldehyde.

In one embodiment, the alkylphenol-aldehyde resin is prepared by reacting, without pre-purification, an alkylphenol composition directly with one or more aldehydes. This so-called “in-situ” alkylphenol composition (i.e., a raw alkylphenol composition prepared, without further processing to obtain a purified alkylphenol component) may comprise at least about 0.1 wt %, about 0.2 wt %, about 0.5 wt %, or about 1 wt % phenol.

In one embodiment, the alkylphenol-aldehyde resin contains less than about 10%, about 5%, about 3%, about 2%, or about 1% free phenolic monomers. For instance, when the alkylphenol-aldehyde resin is prepared by reacting an in-situ PTBP/PTOP with aldehydes, the free phenolic monomers, including free phenol, PTBP, and PTOP, may be less than about 10%, about 5%, about 3%, about 2%, or about 1%.

The alkylphenol-aldehyde resin may be a novolac resin.

The component b) in the phenolic resin composition is an antioxidant composition. The antioxidant composition comprises i) pentanedioic acid, 2-[3,5-di-tert-butyl-4-hydroxybenzyl] C₁-C₁₀ dialkyl ester; ii) 3,5-di-tert-butyl-4-hydroxyhydrocinnamic acid, C₁-C₁₀ alkyl ester; iii) 3,3′,5,5′-tetra-tert-butyl-4,4′-biphenol

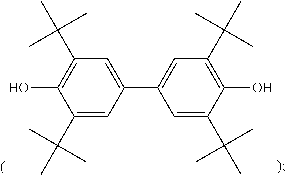

iv) 2,2′,6,6′-tetra-tert-butyl-4,4′-methylenediphenol

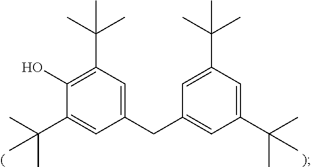

and v) methyl 3-(3,5-di-tert-butyl-4-oxocyclohexa-2,5-dien-1-ylidene) propanoate

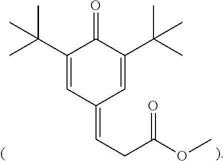

In the antioxidant composition component b), the component i) can range from about 25-90 wt %, for instance, from about 25-45 wt %, from about 50-90 wt %, or from about 60-80 wt %. The component ii) can range from about 0.1-25 wt %, for instance, from about 0.1-15 wt %, from about 1-10 wt %, from about 2-5 wt %, or from about 10-25 wt %. The component iii) can range from about 3-20 wt %, for instance, from about 3-15 wt %, from about 5-15 wt %, or from about 5-10 wt %. The component iv) can range from about 3-20 wt %, for instance, from about 3-15 wt %, from about 5-15 wt %, from about 5-10 wt %, or from about 10-20 wt %. The component v) can range from about 0.1-10 wt %, for instance, from about 0.5-5 wt %, or from about 1-5 wt %.

In one embodiment, the antioxidant component b) comprises: i) about 25-90 wt % pentanedioic acid, 2-[3,5-di-tert-butyl-4-hydroxybenzyl] C₁-C₁₀ dialkyl ester; ii) about 0.1-25 wt % 3,5-di-tert-butyl-4-hydroxyhydrocinnamic acid, C₁-C₁₀ alkyl ester; iii) about 3-20 wt % 3,3′,5,5′-tetra-tert-butyl-4,4′-biphenol; iv) about 3-20 wt % 2,2′,6,6′-tetra-tert-butyl-4,4′-methylenediphenol; and v) about 0.1-10 wt % methyl 3-(3,5-di-tert-butyl-4-oxocyclohexa-2,5-dien-1-ylidene) propanoate.

In one embodiment, the antioxidant component b) comprises: i) about 50-90 wt % pentanedioic acid, 2-[3,5-di-tert-butyl-4-hydroxybenzyl] C₁-C₁₀ dialkyl ester; ii) about 0.1-25 wt % 3,5-di-tert-butyl-4-hydroxyhydrocinnamic acid, C₁-C₁₀ alkyl ester; iii) about 3-20 wt % 3,3′,5,5′-tetra-tert-butyl-4,4′-biphenol; iv) about 3-20 wt % 2,2′,6,6′-tetra-tert-butyl-4,4′-methylenediphenol; and v) about 0.1-10 wt % methyl 3-(3,5-di-tert-butyl-4-oxocyclohexa-2,5-dien-1-ylidene) propanoate.

In one embodiment, the antioxidant component b) comprises: i) about 50-90 wt % pentanedioic acid, 2-[3,5-di-tert-butyl-4-hydroxybenzyl] C₁-C₁₀ dialkyl ester; ii) about 0.1-15 wt % 3,5-di-tert-butyl-4-hydroxyhydrocinnamic acid, C₁-C₁₀ alkyl ester; iii) about 3-15 wt % 3,3′,5,5′-tetra-tert-butyl-4,4′-biphenol; iv) about 3-15 wt % 2,2′,6,6′-tetra-tert-butyl-4,4′-methylenediphenol; and v) about 0.1-10 wt % methyl 3-(3,5-di-tert-butyl-4-oxocyclohexa-2,5-dien-1-ylidene) propanoate.

In one embodiment, the antioxidant component b) comprises: i) about 60-80 wt % pentanedioic acid, 2-[3,5-di-tert-butyl-4-hydroxybenzyl] C₁-C₁₀ dialkyl ester; ii) about 1-10 wt % 3,5-di-tert-butyl-4-hydroxyhydrocinnamic acid, C₁-C₁₀ alkyl ester; iii) about 5-10 wt % 3,3′,5,5′-tetra-tert-butyl-4,4′-biphenol; iv) about 5-10 wt % 2,2′,6,6′-tetra-tert-butyl-4,4′-methylenediphenol; and v) about 1-5 wt % methyl 3-(3,5-di-tert-butyl-4-oxocyclohexa-2,5-dien-1-ylidene) propanoate.

The C₁-C₁₀ dialkyl in the pentanedioic acid, 2-[3,5-di-tert-butyl-4-hydroxybenzyl] C₁-C₁₀ dialkyl ester can be dimethyl, diethyl, dipropyl, dibutyl, dihexyl, diheptyl, diisoheptyl, dioctyl, diisooctyl, or di-2-ethylhexyl. In one embodiment, the pentanedioic acid, 2-[3,5-di-tert-butyl-4-hydroxybenzyl] C₁-C₁₀ dialkyl ester is pentanedioic acid, 2-[3,5-di-tert-butyl-4-hydroxybenzyl] dimethyl ester

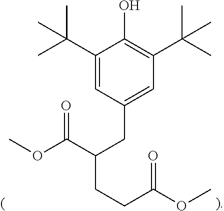

The C₁-C₁₀ alkyl in the 3,5-di-tert-butyl-4-hydroxyhydrocinnamic acid, C₁-C₁₀ alkyl ester can be methyl, ethyl, propyl, butyl, hexyl, heptyl, isoheptyl, octyl, isooctyl, or 2-ethylhexyl. In one embodiment, the 3,5-di-tert-butyl-4-hydroxyhydrocinnamic acid, C₁-C₁₀ alkyl ester is 3,5-di-tert-butyl-4-hydroxyhydrocinnamic acid, methyl ester

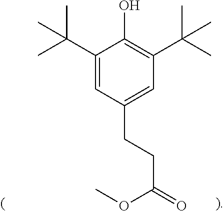

Optionally, the antioxidant composition can further comprise vi) pentaerythritol tetrakis(3-(3,5-di-tert-butyl-4-hydroxyphenyl)propionate), for instance, in the amounts of about 0-10 wt %.

Optionally, the antioxidant composition can further comprise vii) 2,6-di-tert-butylphenol, for instance, in the amounts of about 0-10 wt %.

Optionally, the antioxidant composition can further comprise viii) one or more positional isomers of 3,5-di-tert-butyl-4-hydroxyhydrocinnamic acid, C₁-C₁₀ alkyl ester, and/or other components from the distillation residuum fraction of the reaction product between an alkyl acrylate and an alkylphenol compound, for instance, in the amounts of about 0-40 wt %, or in the amounts of about 0-10 wt %. In one embodiment, component viii) includes one or more positional isomers of 3,5-di-tert-butyl-4-hydroxyhydrocinnamic acid, methyl ester (e.g., benzeneacetic acid. 3,5-bis(1-dimethylethyl)-4-hydroxy-α-methyl-, methyl ester:

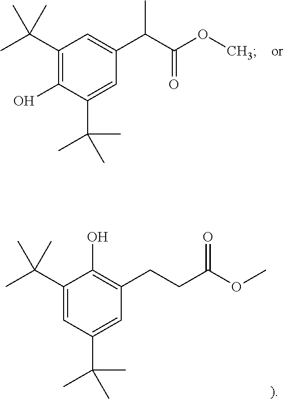

The antioxidant component b) in the phenolic resin composition may be a composition taken directly from the distillation residuum fraction of the reaction product between an alkyl acrylate and an alkylphenol compound, e.g., between methyl acrylate and 2,6-di-tertiary-butylphenol. In this regard, the distillation residuum fraction of the reaction product as a whole, without further processing, is used as the antioxidant component b). Thus, depending on the reaction conditions between the alkyl acrylate and alkylphenol compound, and the distillation temperature and duration, the distillation residuum fraction of the reaction product can contain various amounts of components i)-viii) above. In certain embodiments, one or more of components ii)-viii) may or may not be present in the antioxidant component b). Therefore, the embodiments of the invention also encompass the amount ranges of components ii)-viii), as discussed above, adjusted to reflect the scenarios when one or more of components ii)-viii) are absent. For instance, the component ii) can range from about 0-25 wt %, the component iii) can range from about 0-20 wt %, the component iv) can range from about 0-20 wt %, and the component v) can range from about 0-10 wt %.

In the phenolic resin composition, the component a) typically ranges from about 50 wt % to about 95 wt %, and the component b) typically ranges from about 5 wt % to about 50 wt %. For instance, the component a) can range from about 65 wt % to about 95 wt %, and the component b) can range from about 5 wt % to about 35 wt %. Alternatively, the component a) can range from about 70 wt % to about 80 wt %, and the component b) can range from about 20 wt % to about 30 wt %.

The softening point of the resulting phenolic resin composition typically ranges from about 80 to about 140° C., for instance, from about 80 to about 110° C., or from about 80 to about 100° C. Adding more antioxidant component b) in the phenolic resin composition can lower the softening point. If the phenolic resin composition is used as a tackifier, it is desirable to add the antioxidant component b) to the extent that the softening point is no lower than 80° C.

The phenolic resin composition described herein has a tack performance comparable to that of the commercial alkylphenol-aldehyde tackifier resins. Accordingly, one aspect of the invention relates to a tackifier composition comprising the phenolic resin composition described, supra.

The phenolic resin composition described herein, when added to a rubber compound, provides the rubber composition with a reduced hysteresis and improved scorch, as compared to the commercial alkylphenol-aldehyde tackifier resins. Accordingly, one aspect of the invention relates to a rubber composition having reduced hysteresis and/or improved scorch, comprising: a natural rubber, a synthetic rubber, or a mixture thereof; and the phenolic resin composition described, supra. The phenolic resin composition reduces the hysteresis increase in a rubber composition otherwise caused when a phenolic resin (e.g., an alkylphenol-aldehyde resin) is added to the rubber composition and/or improves the scorch properties in a rubber composition otherwise worsened when a phenolic resin is added to the rubber composition.

The rubber composition includes a rubber component, such as a natural rubber, a synthetic rubber, or a mixture thereof. For instance, the rubber composition may be a natural rubber composition. Alternatively, the rubber composition can be a synthetic rubber composition. Representative synthetic rubbery polymers include diene-based synthetic rubbers, such as homopolymers of conjugated diene monomers, and copolymers and terpolymers of the conjugated diene monomers with monovinyl aromatic monomers and trienes. Exemplary diene-based compounds include, but are not limited to, polyisoprene such as 1,4-cis-polyisoprene and 3,4-polyisoprene; neoprene; polystyrene; polybutadiene; 1,2-vinyl-polybutadiene; butadiene-isoprene copolymer; butadiene-isoprene-styrene terpolymer; isoprene-styrene copolymer; styrene/isoprene/butadiene copolymers; styrene/isoprene copolymers; emulsion styrene-butadiene copolymer; solution styrene/butadiene copolymers; butyl rubber such as isobutylene rubber; ethylene/propylene copolymers such as ethylene propylene diene monomer (EPDM); and blends thereof. A rubber component, having a branched structure formed by use of a polyfunctional modifier such as tin tetrachloride, or a multifunctional monomer such as divinyl benzene, may also be used. Additional suitable rubber compounds include nitrile rubber, acrylonitrile-butadiene rubber (NBR), silicone rubber, the fluoroelastomers, ethylene acrylic rubber, ethylene vinyl acetate copolymer (EVA), epichlorohydrin rubbers, chlorinated polyethylene rubbers such as chloroprene rubbers, chlorosulfonated polyethylene rubbers, hydrogenated nitrile rubber, hydrogenated isoprene-isobutylene rubbers, tetrafluoroethylene-propylene rubbers, and blends thereof.

The rubber composition can also be a blend of natural rubber with a synthetic rubber, a blend of different synthetic rubbers, or a blend of natural rubber with different synthetic rubbers. For instance, the rubber composition can be a natural rubber/polybutadiene rubber blend, a styrene butadiene rubber-based blend, such as a styrene butadiene rubber/natural rubber blend, or a styrene butadiene rubber/butadiene rubber blend. When using a blend of rubber compounds, the blend ratio between different natural or synthetic rubbers can be flexible, depending on the properties desired for the rubber blend composition.

Also, the rubber composition may comprise additional materials, such as a methylene donor, one or more other rubber additives, one or more reinforcing materials, and one or more oils. As known to one skilled in the art, these additional materials are selected and commonly used in conventional amounts.

Suitable methylene donors include, for instance, hexamethylenetetramine (HMTA), di-, tri-, tetra-, penta-, or hexa-N-methylol-melamine or their partially or completely etherified or esterified derivatives, for example hexa(methoxymethyl)melamine (HMMM), oxazolidine or N-methyl-1,3,5-dioxazine, and mixtures thereof.

Suitable other rubber additives include, for instance, sulfur, zinc oxides, silica, waxes, antioxidant, antiozonants, peptizing agents, fatty acids, stearates, accelerators (e.g., sulfur accelerators), curing agents, activators, retarders (e.g., scorch retarders), a cobalt, adhesion promoters, plasticizers, pigments, additional fillers, and mixtures thereof.

Suitable oils include, for instance, mineral oils and naturally derived oils. Examples of naturally derived oils include tall oil, linseed oil, cashew nut shell liquid, and/or twig oil. Commercial examples of tall oil include, e.g., SYLFAT® FA-1 (Arizona Chemicals) and PAMAK 4® (Hercules Inc.). The oils may be contained in the rubber composition, relative to the total weight of rubber compounds in the composition, in amounts less than about 5 wt %, for instance, less than about 2 wt %, less than about 1 wt %, less than about 0.6 wt %, less than about 0.4 wt %, less than about 0.3 wt %, or less than about 0.2 wt %. The presence of an oil in the rubber composition may aid in providing improved flexibility of the rubber composition after vulcanization.

The rubber compositions can be vulcanized by using mixing equipment and procedures conventionally employed in the art, such as mixing the various vulcanizable polymer(s) with the phenolic resin compositions, and commonly used additive materials such as, but not limited to, curing agents, activators, retarders and accelerators; processing additives, such as oils; plasticizers; pigments; additional fillers; fatty acid; stearates; adhesive promoters; zinc oxide; waxes; antioxidants; antiozonants; peptizing agents; and the like. As known to those skilled in the art, the additives mentioned above are selected and commonly used in conventional amounts.

The vulcanizable rubber composition can then be processed according to ordinary rubber manufacturing techniques. Likewise, the final rubber products can be fabricated by using standard rubber curing techniques. For further explanation of rubber compounding and the additives conventionally employed, one can refer to The Compounding and Vulcanization of Rubber, by Stevens in Rubber Technology, Second Edition (1973 Van Nostrand Reinhold Company), which is incorporated herein by reference in their entirety.

The rubber compounds can be cured in a conventional manner with known vulcanizing agents at about 0.1 to 10 parts per hundred rubber (phr). A general disclosure of suitable vulcanizing agents, such as sulfur or peroxide-based curing agents, can be found in Kirk-Othmer, Encyclopedia of Chemical Technology (3rd ed., Wiley Interscience, N.Y. 1982), vol. 20, pp. 365-468, particularly Vulcanization Agents and Auxiliary Materials, pp. 390-402, or Vulcanization by A. Y. Coran, Encyclopedia of Polymer Science and Engineering (2^{nd} ed., John Wiley & Sons, Inc., 1989), both of which are incorporated herein by reference. Vulcanizing agents can be used alone or in combination.

Curing may be conducted in the presence of a sulfur curing agent. Examples of suitable sulfur vulcanizing agents include Rubbermakers's soluble sulfur; sulfur donating vulcanizing agents, such as an amine disulfide, polymeric polysulfide or sulfur olefin adducts; and insoluble polymeric sulfur. For instance, the curing agent may be soluble sulfur or a mixture of soluble and insoluble polymeric sulfur. The sulfur curing agents can be used in an amount ranging from about 0.1 to about 25 phr, alternatively from about 1.0 to about 10 phr, from about 1.5 to about 7.5 phr, or from about 1.5 to about 5 phr.

The rubber composition containing the rubber component and the phenolic resin composition according to this invention exhibits superior properties, including reduced hysteresis and improved scorch. Accordingly, the rubber composition can be useful to make a wide variety of products including, for instance, tires or tire components, such as sidewall, shoulder, tread (or treadstock, subtread), bead, plies, belts, liner, chafer, carcass ply, body ply skim, wirecoat, beadfiller, or overlay compounds for tires. Suitable products also include hoses, power belts, conveyor belts, printing rolls, rubber shoe heels, rubber shoe soles, rubber wringers, automobile floor mats, mud flaps for trucks, ball mill liners, and weather strips. One embodiment of this invention relates to tires containing the rubber component and the phenolic resin composition described, supra.

The phenolic resin composition described, supra, may be added to a rubber composition in the same amount, in the same manner, and for the same uses as known alkylphenol-aldehyde resins (such as when used as a tackifier). In one embodiment, the phenolic resin composition is used in an amount ranging from about 0.1 phr to 10 phr, for instance, from about 0.5 phr to 10 phr, from about 1 phr to about 7 phr, from about 2 phr to about 6 phr, or from about 1 phr to about 5 phr.

Another aspect of the invention relates to a process of reducing hysteresis and/or improving scorch in a phenolic resin, comprising: mixing a) a phenolic resin composition comprising one or more alkylphenol-aldehyde resins; and b) an antioxidant composition. The antioxidant composition comprises i) pentanedioic acid, 2-[3,5-di-tert-butyl-4-hydroxybenzyl]C₁-C₁₀ dialkyl ester; ii) 3,5-di-tert-butyl-4-hydroxyhydrocinnamic acid, C₁-C₁₀ alkyl ester; iii) 3,3′,5,5′-tetra-tert-butyl-4,4′-biphenol; iv) 2,2′,6,6′-tetra-tert-butyl-4,4′-methylenediphenol; and v) methyl 3-(3,5-di-tert-butyl-4-oxocyclohexa-2,5-dien-1-ylidene) propanoate. The addition of the antioxidant composition to the phenolic resin composition provides reduced hysteresis and/or improved scorch resistance to a rubber composition containing the phenolic resin composition.

All the descriptions in the above embodiments relating to the phenolic resin composition and its alkylphenol-aldehyde resin component a), and the antioxidant component b), including their compositions, various concentration ranges, and preferred embodiments are suitable in the process of reducing hysteresis and/or improving scorch in a phenolic resin.

The heat buildup of the cured rubber article can typically be measured using a BF Goodrich flexometer. The flexometer measures the heat generation of the rubber compound, and, because the stretch/compression applies to the whole sample, is a more direct measure of the heat buildup of the rubber article. A rubber formula with a lower value measured by the flexometer has a decreased amount of energy loss by the rubber and thus, has a lower heat buildup.

While adding a phenolic resin into a rubber compound generally increases the hysteresis (i.e., heat buildup) of the rubber compound, adding the same phenolic resin together with the antioxidant component b) disclosed herein can reduce the hysteresis increase in the rubber compound that is otherwise caused by adding the phenolic resin into a rubber compound (i.e., the heat buildup does not increase as much when the same phenolic resin is added together with the antioxidant component b)). Using the process disclosed herein, the addition of the antioxidant component b) to the phenolic resin composition reduces the hysteresis increase for at least 2%, 4%, or 6% in a rubber composition containing the phenolic resin composition, measured by a BF Goodrich flexometer.

The scorching property is typically measured by Mooney scorch time, which indicates how fast the rubber compound viscosity increases during extrusion processes. The scorching property may be measured by an RPA 2000, available from Alpha Technologies. Typically, the time required for an increase of 5, 10, and 35 Mooney units is measured for the scorching property.

While adding a phenolic resin into a rubber compound generally deteriorates the scorch time of the rubber compound, adding the same phenolic resin together with the antioxidant component b) disclosed herein can improve the scorching properties in the rubber compound that are otherwise worsened by adding the phenolic resin into a rubber compound (i.e., the scorch does not deteriorate as much when the same phenolic resin is added together with the antioxidant component b)). Using the process disclosed herein, the addition of the antioxidant component b) to the phenolic resin composition provides at least 5% or 8% improvement in scorch time to a rubber composition containing the phenolic resin composition, measured by a Mooney Scorch test at 127° C. for 60 minutes.

Alternatively, it is contemplated that the antioxidant composition component b) and the phenolic resin composition component a) can be separately added to a rubber composition, without pre-mixing the two components, to reduce the hysteresis increase in the rubber composition otherwise caused when a phenolic resin is added to the rubber composition and/or improve the scorch properties in the rubber composition otherwise worsened when a phenolic resin is added to the rubber composition.

Accordingly, it is contemplated that the process of reducing hysteresis and/or improving scorch in a phenolic resin can also be carried out by mixing the phenolic resin composition component a) and the antioxidant composition component b) with the rubber composition described, supra, simultaneously, or sequentially, with any order of adding the component a), component b), and the rubber composition.

The antioxidant component b) in the phenolic resin composition can be prepared from a reaction between an alkyl acrylate and an alkylphenol compound. This involves a Michael reaction, or other chemical reactions, for preparing hindered phenolic esters. Purified forms of these esters are typically desired for utilization as antioxidants. Thus, the manufacture of these hindered phenolic esters often result in large amounts of distillation bottom fractions accumulating in the bottom of the distillation reactors as waste materials, creating difficult problems for waste disposal.

The inventors of this invention have unexpectedly discovered that these distillation bottom fractions can be added to an alkylphenol-aldehyde resin to be used as tackifier compositions, thereby solving the difficult problems of waste disposal from the reaction and, at the same time, efficiently recycling these reaction by-products as a useful tackifier.

Accordingly, one aspect of the invention relates to a process of recycling by-products of a reaction between an alkyl acrylate and an alkylphenol compound. The process comprises collecting the residuum fraction by-products of the reaction between the alkyl acrylate and the alkylphenol compound, wherein the alkylphenol compound includes 2,6-di-tert-butylphenol or 2,4-di-tert-butylphenol; and mixing the by-products with a tackifier resin composition comprising one or more alkylphenol-aldehyde resins, thereby recycling the by-products as a tackifier composition.

Alternatively, it is contemplated that the collected residuum fraction by-products can be separately added to a rubber composition, without pre-mixing with a tackifier resin composition, when recycling the by-products as a tackifier composition.

Accordingly, it is contemplated that the recycling process can also be carried out by mixing the collected residuum fraction by-products with the rubber composition described, supra, with or without adding the tackifier resin composition comprising one or more alkylphenol-aldehyde resins. When the tackifier resin composition is also added to the rubber composition, it can be added simultaneously with the collected residuum fraction by-products, or before or after adding the collected residuum fraction by-products.

The recycled compounds (i.e., the recycled residuum fraction by-products) can comprise the products of any Michael reaction, or similar chemical reaction, involving reacting an alkyl acrylate with an alkylphenol compound.

In a typical Michael reaction, the reaction between the alkyl acrylate and the alkylphenol compound produces various hindered phenolic esters as well as various by-products. Typically, through purification, the hindered phenolic esters are collected for utilization as antioxidants. The recycling process involves collecting the residuum fraction by-products of the reaction between the alkyl acrylate and the alkylphenol compound, and then mixing these by-products with a tackifier resin composition to recycle the by-products as a tackifier composition.

The alkylphenol compound can be 2,6-di-tert-butylphenol; 2,4-di-tert-butylphenol; or combinations thereof.

Suitable alkyl acrylates are C₁-C₂₄ alkyl acrylates, for instance, C₁-C₁₀ alkyl acrylates. Exemplary alkyl acrylates are methyl acrylate, ethyl acrylate, propyl acrylate, n-butyl acrylate, sec-butyl acrylate, 2-ethylhexyl acrylate, n-octyl acrylate, isooctyl acrylate, and n-octadecyl acrylate.

The recycling process can apply to the reaction by-products produced from a wide range of alkyl acrylate to alkylphenol compound ratios. Either of the alkyl acrylate and alkylphenol compound may be used in excess. A typical Michael reaction employs about equimolar portions of alkyl acrylate and alkylphenol compound. In certain embodiments, the molar ratio of the alkyl acrylate to the alkylphenol compound ranges from about 0.95:1 to about 1.30:1.

In an exemplary embodiment, the recycling process applies to the by-products produced from the reaction between methyl arylate and 2,6-di-tert-butylphenol. Various hindered phenolic esters (including pentanedioic acid, 2-[3,5-di-tert-butyl-4-hydroxybenzyl]dimethyl ester and 3,5-di-tert-butyl-4-hydroxyhydrocinnamic acid, methyl ester) as well as various by-products can be produced from this reaction. Typically, much of the dimethyl ester and methyl ester are collected through distillation for utilization as antioxidants. The residuum fraction by-products result from the distillation, depending on the distillation temperature and duration can contain the following compounds:

| Compound | Wt % |
|---|---|
| pentanedioic acid, 2-[3,5-di-tert-butyl-4-hydroxy- | 60-80 |
| benzyl] dimethyl ester | |
| 3,5-di-tert-butyl-4-hydroxyhydrocinnamic acid, methyl | 1-10 |
| ester | |
| 3,3′,5,5′-tetra-tert-butyl-4,4′-biphenol | 5-10 |
| 2,2′,6,6′-tetra-tert-butyl-4,4′-methylenediphenol | 5-10 |
| methyl 3-(3,5-di-tert-butyl-4-oxocyclohexa-2,5-dien-1- | 1-5 |
| ylidene) propanoate | |
| pentaerythritol tetrakis(3-(3,5-di-tert-butyl-4-hydroxy- | 0-10 |
| phenyl)propionate) | |
| 2,6-di-tert-butylphenol | 0-10 |
| benzeneacetic acid, 3,5-bis(1,1-dimethylethyl)-4-hydroxy- | 0-40 |
| α-methyl-, methyl ester | |

These residuum fraction by-products are then mixed with the tackifier resin composition discussed above to recycle the by-products as a tackifier composition.

In one embodiment, the residuum fraction by-products contain the following compounds:

| Compound | Wt % |
|---|---|
| pentanedioic acid, 2-[3,5-di-tert-butyl-4-hydroxybenzyl] | 77.64 |
| dimethyl ester | |
| 3,5-di-tert-butyl-4-hydroxyhydrocinnamic acid, methyl ester | 3.78 |
| 3,3′,5,5′-Tetra-tert-butyl-4,4′-biphenol | 7.78 |
| 2,2′,6,6′-tetra-tert-butyl-4,4′-methylenediphenol | 9.57 |
| methyl 3-(3,5-di-tert-butyl-4-oxocyclohexa-2,5-dien-1-ylidene) | 1.23 |
| propanoate | |

All the descriptions in the above embodiments relating to the tackifier resin composition (i.e., the phenolic resin composition) comprising one or more alkylphenol-aldehyde resins and preferred embodiments are suitable in the recycling process. All the descriptions in the above embodiments relating to the antioxidant component b) are applicable to the residuum fraction by-products in the recycling process.

### EXAMPLES

The following examples are given as particular embodiments of the invention and to demonstrate the practice and advantages thereof. It is to be understood that the examples are given by way of illustration and are not intended to limit the specification or the claims that follow in any manner.

### Example 1: Preparation of an Antioxidant Component b)

An exemplary antioxidant component b) was prepared according to the following procedure.

A reactor was initially charged with molten 2,6-di-tert-butylphenol (2,6-DTBP) (68.2 wt % of total reactants) at about 40-50° C. and KOH solution (0.37 wt % of total reactants). The pressure was then reduced to 20 mm Hg and the temperature was increased to about 115° C. over 1-1.5 hours to remove the water by-product. The resulting white slurry was then cooled to about 80° C.

Under reflux condition, methyl acrylate (31.1 wt % of total reactants) was then added dropwise to the reactor over a period of time while the reactor temperature was allowed to rise from about 80° C. to about 120° C., and maintained at about 120° C. over a period of time before cooling to about 90-120° C.

Under distillation condition, the volatile phenolic esters were collected, and the distillation bottom (the residuum fraction) of the reaction products, which appeared in dark brown solid form under the room temperature, was separately collected as the antioxidant component b).

### Example 2: Formulation of Rubber Compounds Containing Various Tackifier Resins

A standard rubber compound cured with sulfur, having the formulation shown in Table 1, was used for the measurements of the properties in Example 3.

TABLE 1
Summary of the formulation for the rubber composition

| | phr |
|---|---|
| Rubber Compound | |
| Synthetic Rubber (BR9000) | 50 |
| Natural Rubber (SMR20) | 50 |
| N326 carbon black | 23 |
| N375 carbon black | 27 |
| Aromatic Oil | 7 |
| Stearic acid | 2 |
| Zinc oxide | 3.5 |
| Rubber Antioxidant TMQ | 1 |
| Antioxidant DTPD (3100) | 1 |
| Antioxidant 6PPD (4020) | 3 |
| Microcrystalline wax | 2 |
| Total MasterBatch | 169.5 |
| Resin | |
| Tackifier resin | 3.00 |
| Cure Package | |
| Insoluble sulfur | 1.50 |
| Accelerator TBBS (2-mercaptobenzothiazole) | 0.80 |
| Anti-scorching agent CTP (N-(cyclohexylthio) | 0.27 |
| phthalimide) | |

The rubber mix, using the formulation from Table 1 (including the Rubber Compound and the Resin, except the Cure Package), was prepared according to the mixing procedure described in Table 2.

TABLE 2
Summary of the rubber mixing procedures
Initial Rotor speed: 35 rpm
Initial temperature: 80° C.

| Run Time (min) | Mixing Procedure |
|---|---|
| 1:00 | Rubbers (natural rubber + synthetic rubber), 35 rpm |
| 0:30 | Tackifier resin + stearic acid + others, 55 rpm |
| 1:30 | >½ carbon black, 55 rpm |
| 1:00 | <½ carbon black, 55 rpm |
| 0:30 | Mixing, 65 rpm |
| | Ram up |
| 0:10 | Clean |
| 1:00 | Mixing, 65 rpm |
| 0:10 | End and drop down |
| 5:50 | Total Time (min) |

After the rubber compound and the tackifier resin were pre-mixed according to the mixing procedure in Table 2, the rotor speed was set to 25 rpm at 50° C., and the Cure Package as listed in Table 1 was added to the pre-mix. The temperature was elevated to 100° C. and held for about 1 minute and mixing was conducted for about 1 minute.

The various tackifier resin samples used in the rubber composition listed in Table 1 are shown in Table 3 below. As shown in Table 3, Blank indicates blank reference, i.e., there is no tackifier resin added to the rubber composition; Tackifier 1 represents an alkylphenol-aldehyde tackifier resin, prepared by reacting, without pre-purification, para-tert-octylphenol (PTOP) with formaldehyde; Tackifier 2 represents an alkylphenol-aldehyde tackifier resin similarly prepared as Tackifier 1, but with a higher molecular weight; Tackifier 3 represents an alkylphenol-aldehyde tackifier resin, prepared by reacting, without pre-purification, PTOP/para-tert-butylphenol (PTBP) with formaldehyde; Resin A represents 80 wt % Tackifier 3+20 wt % antioxidant component b); Resin B represents 75 wt % Tackifier 3+25 wt % antioxidant component b); and Resin C represents 70 wt % Tackifier 3+30 wt % antioxidant component b). Tackifiers 1-3 are all commercially available tackifier resins. The antioxidant component b) was prepared according to Example 1.

TABLE 3
Tackifier resin samples and their softening points.

| Tackifier resin samples | Softening point(° C.) |
|---|---|
| Blank (no tackifier resin) | |
| Tackifier 1 | 90.5 |
| Tackifier 2 | 95 |
| Tackifier 3 | 106 |
| Resin A | 97.3 |
| Resin B | 93.3 |
| Resin C | 88.6 |

In Tackifier 3, the amounts of free phenolic monomers were: 0.25 wt % free phenol, 0.45% PTBP, and 1.29% PTOP. In Resin A, the amounts of free phenolic monomers were: 0.31 wt % free phenol, 0.39% PTBP, and 1.25% PTOP. In Resin B, the amounts of free phenolic monomers were: 0.32 wt % free phenol, 0.38% PTBP, and 1.23% PTOP. In Resin C, the amounts of free phenolic monomers were: 0.28 wt % free phenol, 0.31% PTBP, and 1.25% PTOP.

### Example 3: The Properties of the Rubber Compounds Containing Various Tackifier Resins

The following measurements were performed in all the rubber compositions containing the tackifier resin samples listed in Table 3, prepared according to Example 2.

### Rheological Properties

Mooney Scorch time (in minutes) was measured at 127° C. with a test time of 60 minutes for the rubber compositions containing each tackifier resin sample. This parameter indicates how fast the rubber compound viscosity increases during extrusion processes and evaluates the processibility of the rubber compound. The results are shown in FIG. 1. T5, T10, and T35 in FIG. 1 show the time required for an increase of 5, 10, and 35 Mooney units, respectively.

As shown in FIG. 1, adding a tackifier resin into a rubber compound deteriorated the scorching property of the rubber compound in general. However, compared to the commercial alkylphenol-aldehyde tackifier resins, Tackifiers 1-3, Resins A-C containing various concentrations of the antioxidant component b) conferred a longer scorch time to the rubber compound. For instance, for T5, the rubber compound containing Resin C had a 8.91% improvement in scorch time than the rubber compound containing Tackifier 3; for T10, the rubber compound containing Resin C had a 8.33% improvement in scorch time than the rubber compound containing Tackifier 3; and for T35, the rubber compound containing Resin C had a 8.77% improvement in scorch time than the rubber compound containing Tackifier 3. This improvement was consistent for all concentrations of the antioxidant component b) tested (i.e., for all Resins A-C), and over all the commercial alkylphenol-aldehyde tackifier resins tested (i.e., over all Tackifiers 1-3).

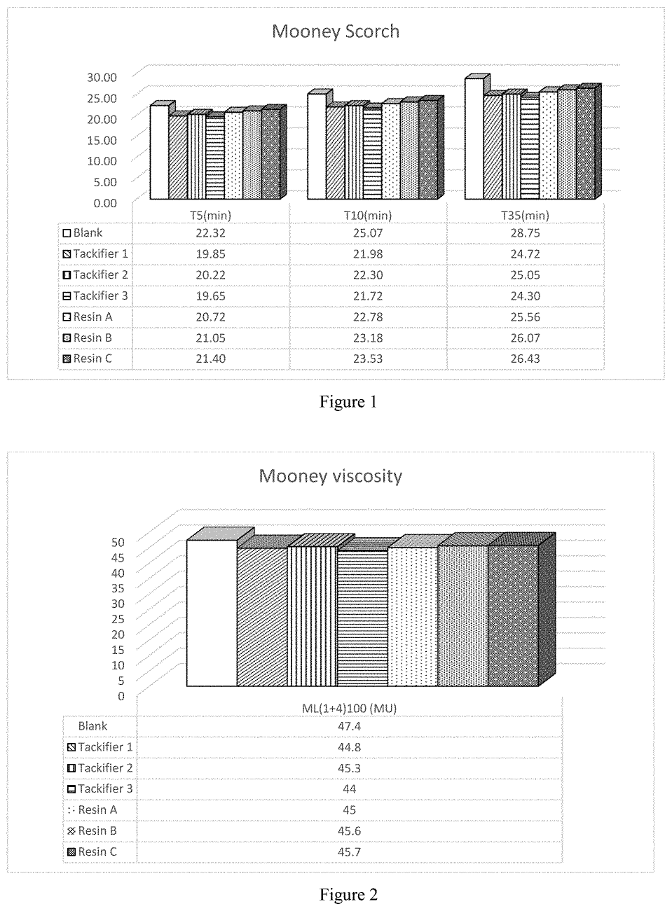

Mooney viscosity was measured at 100° C. with a test time of 4 minutes complying with the ASTM D 1646 standard, for the rubber compositions containing each tackifier resin samples. This parameter, together with Mooney scorch, evaluates the processibility of the rubber compound. The results are shown in FIG. 2. “ML(1+4)100 (MU)” stands for viscosity in Mooney units tested at 100° C., using a large rotor, with a preheat time of 1 minute and a testing time of 4 minutes after starting the motor. As shown in FIG. 2, adding a tackifier resin into a rubber compound generally decreased the viscosity of the rubber compound. The viscosity decrease caused by adding Resins A-C containing the antioxidant component b) was comparable to that caused by adding the commercial alkylphenol-aldehyde tackifier resins, Tackifiers 1-3.

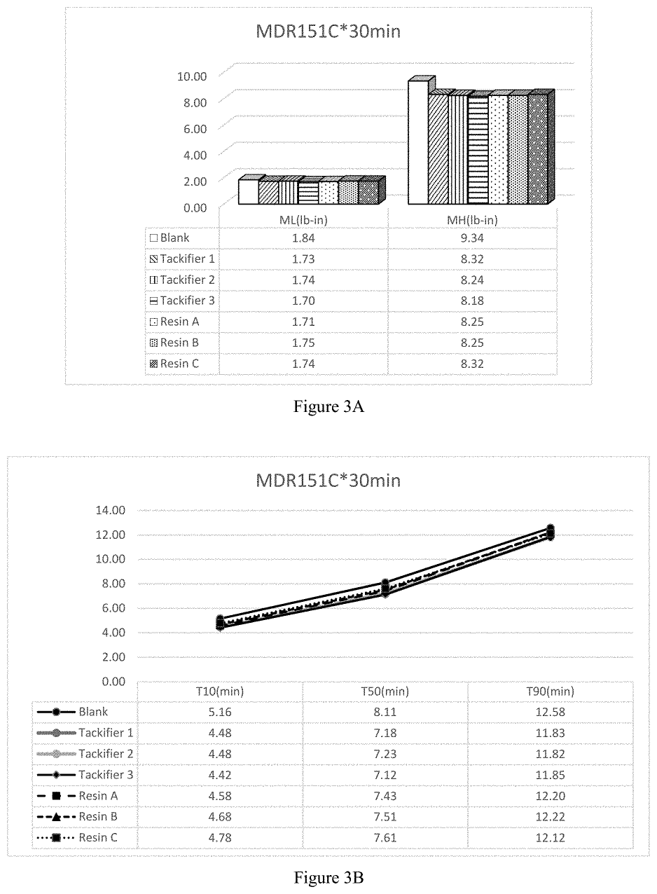

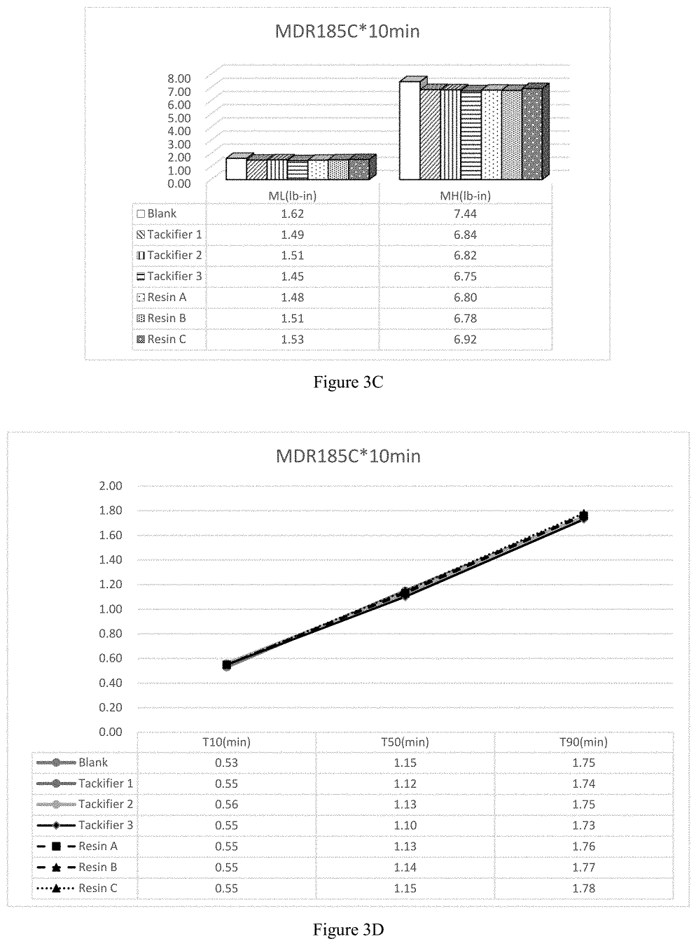

Rheological measurements for the rubber compositions containing various tackifier resin samples using an MDR 2000 (Moving Die Rheometer) rheometer of Alpha Technologies were produced at 151° C. with a test time of 30 minutes and at 185° C. with a test time of 10 minutes, at a frequency of 1.67 Hz and a strain of 6.98%. The results are shown in FIGS. 3A-3D. This parameter indicates the change in stiffness of the rubber compound, and measures the curing phase of the rubber compound. T10, T50, and T90 in FIGS. 3B and 3D show the time corresponding to 10%, 50%, and 90% curing, respectively; and MH and ML show the measured maximum and minimum torques. As shown in FIGS. 3A and 3C, adding Resins A-C containing the antioxidant component b) did not change the extent of cure for the rubber compound, as compared to other commercial alkylphenol-aldehyde tackifier resins, Tackifiers 1-3, yet provided improved scorching property, as discussed above.

### Tensile Properties

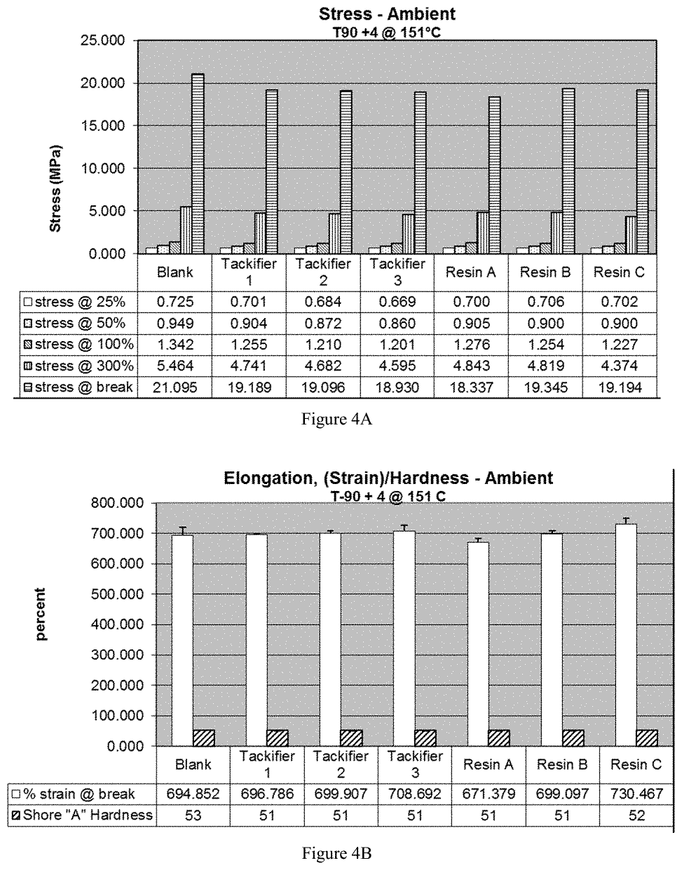

The tensile mechanical properties (stress and elongation) for the rubber compositions containing various tackifier resin samples were measured with heat press machine for stress and elongation by an Instron 3367 using the standard procedure complying with ASTM D412. “T90+4@151° C.” stands for the test being conducted when the rubber compound reaches 90% curing at 151° C. and then adding 4 minutes for curing time base on the MDR test. The results are shown in FIG. 4A-4B. As shown in FIGS. 4A-4B, adding Resins A-C containing the antioxidant component b) did not change physical properties such as tensile properties for the rubber compound, as compared to other commercial alkylphenol-aldehyde tackifier resins, Tackifiers 1-3.

### Hysteresis

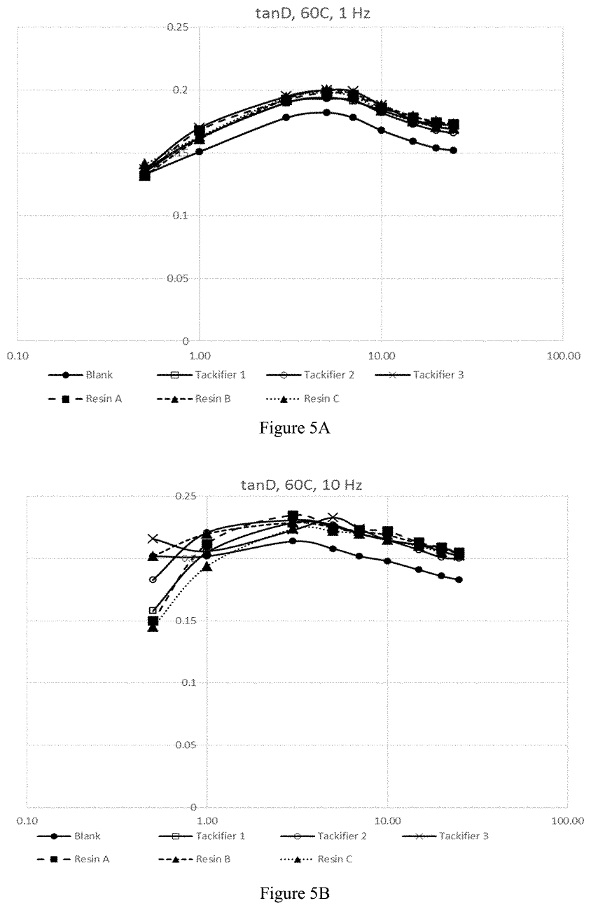

The tan 6 values for the rubber compositions containing various tackifier resin samples were determined by using a Rheometrics Process Analyzer (RPA) at a series of strains at 60° C., and with a frequency of 1 Hz and 10 Hz, respectively. The results are shown in FIGS. 5A-5B. This parameter indirectly measures the heat buildup of the rubber composition. As shown in FIGS. 5A-5B, adding a tackifier resin to a rubber composition generally increases tan 6 value (i.e., the heat buildup) of the rubber composition. The changes in tan 6 values caused by adding Resins A-C containing the antioxidant component b) was comparable to that caused by adding the commercial alkylphenol-aldehyde tackifier resins, Tackifiers 1-3.

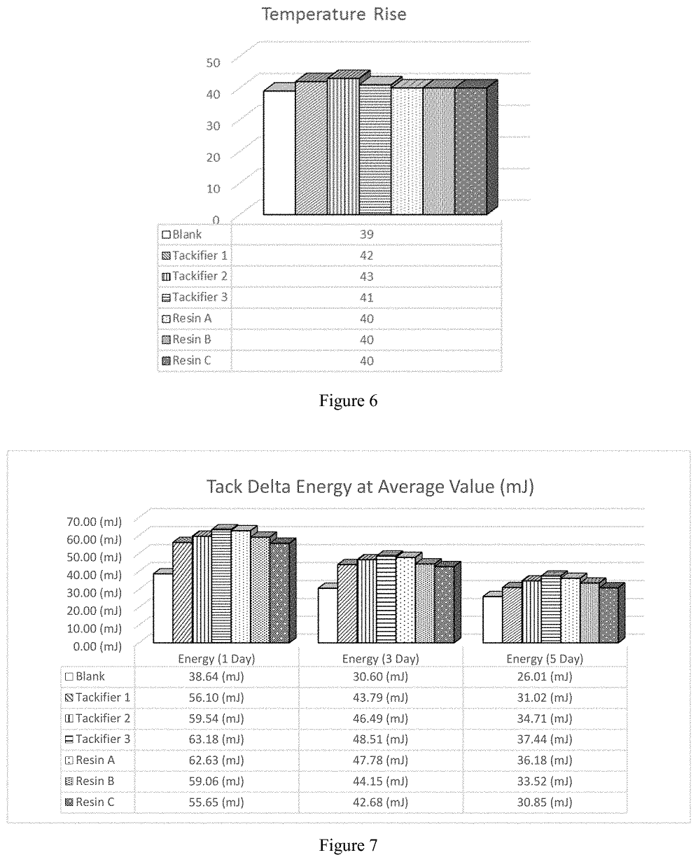

A more direct measure of hysteresis (i.e., heat buildup performance) for the rubber compositions containing various tackifier resin samples was obtained by a standard heat buildup test run at 100° C. with a test time of 25 minutes using a BF Goodrich Flexometer Model II. The temperature change (the heat generation) in response to a compression of the sample was recorded. The results are shown in FIG. 6. The flexometer measures the heat generation and fatigue properties of the rubber compound and, because the stretch/compression applies to the whole sample, is a more direct measurement of the heat buildup following a change in the rubber compound's temperature.

As shown in FIG. 6, adding a tackifier resin to a rubber composition generally increased the heat buildup of the rubber composition. However, compared to the commercial alkylphenol-aldehyde tackifier resins, Tackifiers 1-3, Resins A-C containing various concentrations of the antioxidant component b) caused less of a heat buildup to the rubber compound. For instance, the rubber compound containing Resins A-C had a 2.44%, 4.76%, and 6.98% decrease in the heat buildup than the rubber compound containing Tackifiers 1, 2, and 3, respectively. This improvement was consistent for all concentrations of the antioxidant component b) tested (i.e., for each of Resins A-C), and over all the commercial alkylphenol-aldehyde tackifier resins tested (i.e., over each of Tackifiers 1-3).

### Tack

The tack performance for the rubber compositions containing various tackifier resin samples at Day 1, Day 3, and Day 5, respectively, was measured by a BF Goodrich Portable tack tester with a contact pressure of 5N for 10 seconds and a separation speed at 127 mm/minute. The results are shown in FIG. 7. As shown in FIG. 7, Resins A-C containing the antioxidant component b) provided tack performance comparable to other commercial alkylphenol-aldehyde tackifier resins, Tackifiers 1-3.

1. A phenolic resin composition, comprising:
a) about 50 wt % to about 95 wt % of one or more alkylphenol-aldehyde resins, wherein the alkylphenol in the alkylphenol-aldehyde resin includes butylphenol and/or octylphenol, and
b) about 5 wt % to about 50 wt % of an antioxidant composition comprising:
i) about 25-90 wt % pentanedioic acid, 2-[3,5-di-tert-butyl-4-hydroxybenzyl] C₁-C₁₀ dialkyl ester;
ii) about 0.1-25 wt % 3,5-di-tert-butyl-4-hydroxyhydrocinnamic acid, C₁-C₁₀ alkyl ester;
iii) about 3-20 wt % 3,3′,5,5′-tetra-tert-butyl-4,4′-biphenol;
iv) about 3-20 wt % 2,2′,6,6′-tetra-tert-butyl-4,4′-methylenediphenol; and
v) about 0.1-10 wt % methyl 3-(3,5-di-tert-butyl-4-oxocyclohexa-2,5-dien-1-ylidene) propanoate.

2. The phenolic resin composition of claim 30, wherein the component b) comprises:
i) about 60-80 wt % pentanedioic acid, 2-[3,5-di-tert-butyl-4-hydroxybenzyl]C₁-C₁₀ dialkyl ester;
ii) about 1-10 wt % 3,5-di-tert-butyl-4-hydroxyhydrocinnamic acid, C₁-C₁₀ alkyl ester;
iii) about 5-10 wt % 3,3′,5,5′-tetra-tert-butyl-4,4′-biphenol;
iv) about 5-10 wt % 2,2′,6,6′-tetra-tert-butyl-4,4′-methylenediphenol; and
v) about 1-5 wt % methyl 3-(3,5-di-tert-butyl-4-oxocyclohexa-2,5-dien-1-ylidene) propanoate.

3. The phenolic resin composition of claim 1, wherein the component b) further comprises:
vi) pentaerythritol tetrakis(3-(3,5-di-tert-butyl-4-hydroxyphenyl)propionate).

4. The phenolic resin composition of claim 1, wherein the component b) further comprises:
vii) 2,6-di-tert-butylphenol.

5. The phenolic resin composition of claim 1, wherein the pentanedioic acid, 2-[3,5-di-tert-butyl-4-hydroxybenzyl] C₁-C₁₀ dialkyl ester is pentanedioic acid, 2-[3,5-di-tert-butyl-4-hydroxybenzyl] dimethyl ester, and the 3,5-di-tert-butyl-4-hydroxyhydrocinnamic acid, C₁-C₁₀ alkyl ester is 3,5-di-tert-butyl-4-hydroxyhydrocinnamic acid, methyl ester.

6. The phenolic resin composition of claim 1, wherein the component a) ranges from about 65 wt % to about 95 wt %, and the component b) ranges from about 5 wt % to about 35 wt %.

7. The phenolic resin composition of claim 6, wherein the component a) ranges from about 70 wt % to about 80 wt %, and the component b) ranges from about 20 wt % to about 30 wt %.

8. The phenolic resin composition of claim 1, wherein the butylphenol is para-tert-butylphenol and the octylphenol is para-tert-octylphenol.

9. The phenolic resin composition of claim 1, wherein the alkylphenol-aldehyde resin is prepared by reacting, without pre-purification, an alkylphenol composition comprising at least about 0.1 wt % phenol directly with one or more aldehydes.

10. The phenolic resin composition of claim 9, wherein the alkylphenol-aldehyde resin contains less than 2% free phenolic monomers.

11. The phenolic resin composition of claim 1, wherein the alkylphenol-aldehyde resin is a novolac resin.

12. The phenolic resin composition of claim 1, wherein the softening point of the phenolic resin composition ranges from about 80 to about 100° C.

13. A tackifier composition comprising the phenolic resin composition of claim 1.

14. A rubber composition having reduced hysteresis and/or improved scorch, comprising:
a natural rubber, a synthetic rubber, or a mixture thereof; and
the phenolic resin composition of claim 1, wherein the phenolic resin composition reduces the hysteresis increase in a rubber composition otherwise caused when a phenolic resin is added to the rubber composition and/or improves the scorch properties in a rubber composition otherwise worsened when a phenolic resin is added to the rubber composition.

15-29. (canceled)

30. The phenolic resin composition of claim 1, wherein the component b) comprises:
i) about 50-90 wt % pentanedioic acid, 2-[3,5-di-tert-butyl-4-hydroxybenzyl]C₁-C₁₀ dialkyl ester;
ii) about 0.1-25 wt % 3,5-di-tert-butyl-4-hydroxyhydrocinnamic acid, C₁-C₁₀ alkyl ester;
iii) about 3-20 wt % 3,3′,5,5′-tetra-tert-butyl-4,4′-biphenol;
iv) about 3-20 wt % 2,2′,6,6′-tetra-tert-butyl-4,4′-methylenediphenol; and
v) about 0.1-10 wt % methyl 3-(3,5-di-tert-butyl-4-oxocyclohexa-2,5-dien-1-ylidene) propanoate.

31. The phenolic resin composition of claim 1, wherein the component b) further comprises:
viii) one or more positional isomers of 3,5-di-tert-butyl-4-hydroxyhydrocinnamic acid, methyl ester.

32. The phenolic resin composition of claim 31, wherein the component b) further comprises:
viii) up to about 40 wt % benzeneacetic acid, 3,5-bis(1,1-dimethylethyl)-4-hydroxy-α-methyl-, methyl ester.

33. The phenolic resin composition of claim 1, wherein the component b) comprises:
i) about 25-45 wt % pentanedioic acid, 2-[3,5-di-tert-butyl-4-hydroxybenzyl]C₁-C₁₀ dialkyl ester;
ii) about 0.1-25 wt % 3,5-di-tert-butyl-4-hydroxyhydrocinnamic acid, C₁-C₁₀ alkyl ester;
iii) about 5-15 wt % 3,3′,5,5′-tetra-tert-butyl-4,4′-biphenol;
iv) about 5-15 wt % 2,2′,6,6′-tetra-tert-butyl-4,4′-methylenediphenol;
v) about 1-5 wt % methyl 3-(3,5-di-tert-butyl-4-oxocyclohexa-2,5-dien-1-ylidene) propanoate; and
viii) about 0-40 wt % benzeneacetic acid, 3,5-bis(1,1-dimethylethyl)-4-hydroxy-α-methyl-, methyl ester.
